(19) United States
(12) Patent Application Publication
(10) Pub. No.: US 2018/0347838 A1
(43) Pub. Date: Dec. 6, 2018

(54) AIR CONDITIONER AND METHOD FOR CONTROLLING AN AIR CONTROLLER

(71) Applicant: LG ELECTRONICS INC., Seoul (KR)

(72) Inventor: Junho NO, Seoul (KR)

(73) Assignee: LG Electronics Inc.

(21) Appl. No.: 15/656,006

(22) Filed: Jul. 21, 2017

(30) Foreign Application Priority Data
Jun. 1, 2017 (KR) 10-2017-0068288

(51) Int. Cl. F24F 11/00; F24F 1/00; F24F 13/28; B01D 46/00; B01D 46/44

(52) U.S. Cl. CPC F24F 11/0086; F24F 1/0007; F24F 13/28; F24F 11/0017; B01D 46/0045; B01D 46/442; B01D 2279/50; B01D 46/0038; B01D 46/0023; F24F 2011/0023; F24F 2011/0093; F24F 2011/0038; B01D 46/0086

(57) ABSTRACT

An air conditioner and a method for controlling an air conditioner are provided. The air conditioner may include a fan that suctions in indoor air from an indoor space and exhausts the suctioned air to the indoor space, the fan being driven selectively at one of a plurality of wind speeds; at least one filter provided adjacent to the fan; at least one contamination sensor that senses a contamination level of the indoor air; and a controller electrically connected to the fan and the at least one contamination sensor. An accumulated driving time of the fan may be calculated by the controller considering the wind speed, and an exchanging timing of the at least one filter may be determined by the controller on the basis of the accumulated driving time of the fan. The plurality of wind speeds may include low speed, medium speed, and high speed.

### CROSS-REFERENCE TO RELATED APPLICATION(S)

Pursuant to 35 U.S.C. § 119(a), this application claims the benefit of the Korean Patent Application No. 10-2017-0068288, filed in Korea on Jun. 1, 2017, which is hereby incorporated by reference as if fully set forth herein.

### BACKGROUND

### 1. Field

An air conditioner and a method for controlling are disclosed herein.

### 2. Background

Generally, an air conditioner includes a compressor that compresses a refrigerant, an indoor heat exchanger that exchanges heat with indoor air, an expansion valve that expands the refrigerant, and an outdoor heat exchanger that exchanges heat with outdoor air. The compressor and the outdoor heat exchanger may be provided in an outdoor unit, and the indoor heat exchanger may be provided in an indoor unit. The expansion valve may be provided in at least one of the indoor unit or the outdoor unit.

The indoor unit may be provided with a filter that filters the air entering the indoor unit. For example, the filter may be provided at one side of a fan inside of the indoor unit. In more detail, the filter may be arranged at one side of an air inlet formed in the indoor unit. Therefore, if the fan is driven, the air of an air conditioning space, which enters the indoor unit, may be filtered through the filter, and then may be exhausted to the outside of the indoor unit after exchanging heat with the refrigerant through the indoor heat exchanger.

If the air conditioner is an air cleaner, a configuration of an outdoor unit that includes a compressor and an outdoor heat exchanger and a configuration of an indoor heat exchanger are excluded from the air cleaner, and the air cleaner may include a fan and a filter. If the filter is used for a long time without cleaning, a problem may occur in that a filtering performance of the air exhausted from the indoor unit may be deteriorated due to debris of the filter.

Also, if the filter is not cleaned at an appropriate timing, a problem may occur in that the debris in the filter disturbs a flow path of the air, whereby a wind speed of the exhausted air may be deteriorated or reduced.

An air conditioner, which notifies a user of a cleaning or exchanging timing of a filter on the basis of a time passed from a time when the filter is installed or the time passed from driving of the air conditioner, is generally disclosed. For example, Korean Laid-Open Patent No. 1999-0048551, which is hereby incorporated by reference, discloses such an air conditioner (air cleaner) according to the related art.

However, a cleaning or exchanging timing of the filter may be changed depending on a condition that the indoor unit (or air cleaner) is provided and a wind speed. For example, if the indoor unit or the air cleaner is provided in a relatively dusty environment, it is preferable that the filter is cleaned or exchanged with another one at a relatively short cycle. Also, it is preferable that the filter is cleaned or exchanged with another one at a relatively short cycle if a duration when the wind speed of high is used is longer.

On the other hand, if the indoor unit or the air cleaner is provided in a relatively less dusty environment, the filter may be cleaned or exchanged with another one at a relatively long cycle. Also, the filter may be cleaned or exchanged with another one at a relatively long cycle if a duration when the wind speed of low is used is longer.

The air conditioner of the related art has a problem in that the cleaning or exchanging timing of the filter is determined optionally without considering arrangement condition of the indoor unit. Particularly, if the indoor unit is provided in a relatively dusty environment, a problem occurs in that a user may misunderstand deterioration of air volume of the indoor unit, which is caused by contamination of the filter, as a failure of the fan or the indoor unit.

### BRIEF DESCRIPTION OF THE DRAWINGS

Embodiments will be described in detail with reference to the following drawings in which like reference numerals refer to like elements, and wherein:

FIG. 1 is a schematic diagram of an air conditioner according to an embodiment;

FIG. 2 is a view illustrating a stand type indoor unit;

FIG. 3 is a view illustrating a ceiling-embedded type indoor unit;

FIG. 4 is a block diagram illustrating a connection relationship of main components of an indoor unit according to an embodiment;

FIG. 5 is a block diagram of an air cleaner as an embodiment of an air conditioner; and

FIG. 6 is a flow chart of a method for controlling an air conditioner according to an embodiment.

### DETAILED DESCRIPTION

Reference will now be made to embodiments, examples of which are illustrated in the accompanying drawings. It is to be understood that the accompanying drawings show exemplary embodiments, and are not intended to restrict the scope but intended to describe embodiments.

Also, wherever possible, the same or like reference numbers will be used throughout the drawings to refer to the same or like parts. For convenience of description, a size and shape of each element member shown in the drawings may be enlarged or downsized.

Hereinafter, an air conditioner-according to embodiments will be described with reference to the accompanying drawings.

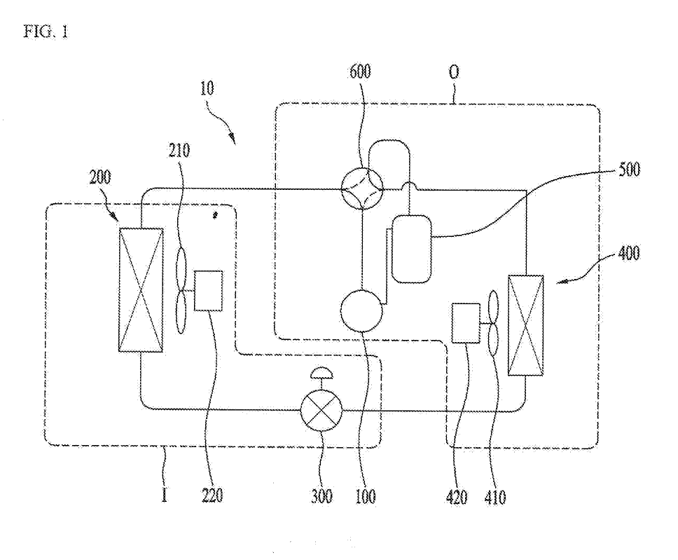

FIG. 1 is a schematic diagram of an air conditioner according to an embodiment. Referring to FIG. 1, an air conditioner 10 according to an embodiment may include a compressor 100, an indoor heat exchanger 200, an expansion valve 300, and an outdoor heat exchanger 400. In this embodiment, “I” may denote an indoor unit, and “O” may denote an outdoor unit. Although the expansion valve 300 is provided in the indoor unit I in FIG. 1, the expansion valve 300 may be provided in the outdoor unit O, or may be provided in each of the indoor unit I and the outdoor unit O.

The compressor 100 may compress a refrigerant. That is, the compressor 100 may make a refrigerant of high temperature and high pressure by pressurizing a refrigerant of low temperature and low pressure. One or more compressors 100 may be provided in the air conditioner 10. If a plurality of compressors 100 are provided in the air conditioner 10, the plurality of compressors 100 may be provided in series and/or in parallel along a flow direction of the refrigerant.

The indoor heat exchanger 200 may exchange heat with indoor air. That is, the indoor heat exchanger 200 may exchange heat between the indoor air and the refrigerant flowing thereinto. For example, the indoor heat exchanger 200 may perform a function of an evaporator in a cooling mode of the air conditioner 10, and may perform a function of a condenser in a heating mode of the air conditioner 10.

The outdoor heat exchanger 400 may perform heat-exchange with outdoor air. That is, the outdoor heat exchanger 400 may perform heat-exchange between the outdoor air and the refrigerant flowing thereinto. For example, the outdoor heat exchanger 400 may perform a function of a condenser in a cooling mode of the air conditioner 10, and may perform a function of an evaporator in a heating mode of the air conditioner 10.

Each of the indoor heat exchanger 200 and the outdoor heat exchanger 400 may be a pin-tube type heat exchanger, for example. Also, the indoor heat exchanger 200 may be provided with a fan 210, and the outdoor heat exchanger 400 may be provided with an outdoor fan 410. The fan 210 may be driven by a first motor 220, and the outdoor fan 410 may be driven by a second motor 420.

The air conditioner 10 may include a path switching valve 600 that switches a circulating direction of the refrigerant when the cooling mode is switched to the heating mode or vice versa. The path switching valve 600 may be formed of a four-way valve. For example, the path switching valve 600 may be formed to guide the refrigerant exhausted from the compressor 100 in the cooling mode to the outdoor unit and guide the refrigerant exhausted from the compressor 100 in the heating mode to the indoor unit.

An accumulator 500 may be provided at one side of the compressor 100. The accumulator 500 may split the refrigerant flowing toward the compressor 100 into a vapor refrigerant and a liquid refrigerant and supply only the vapor refrigerant to the compressor 100.

A filter that filters the air entering the indoor unit I may be provided in the aforementioned indoor unit I. Hereinafter, an arrangement of the filter will be described.

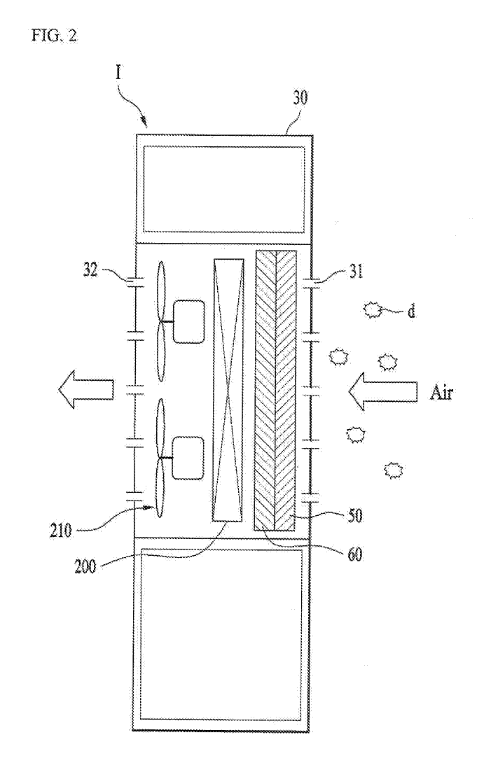

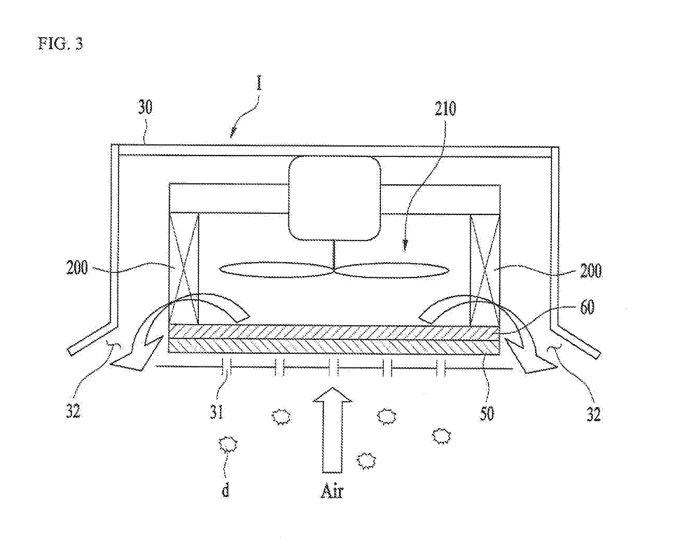

FIG. 2 is a view illustrating a stand type indoor unit. FIG. 3 is a view illustrating a ceiling-embedded type indoor unit.

Referring to FIGS. 2 and 3, the indoor unit I may be provided with filters 50 and 60 that filters air of an air conditioning space. The filters 50 and 60 may be formed to filter debris in the air entering the indoor unit I and remove smell in the air.

The indoor unit I may be provided with an air inlet 31 into which the air flows, and an air outlet 32 from which the air is exhausted. The indoor unit I may include a case 30 that forms an external appearance of the indoor unit I, and the air inlet 31 and the air outlet 32 may be formed in the case 30.

The fan 210, the indoor heat exchanger 200, and the filters 50 and 60 may be arranged in the indoor unit I. The air of the air conditioning space may enter the indoor unit I through the air inlet 31 by means of driving of the fan 210, and may be exhausted to the outside of the indoor unit I by sequentially passing through the filters 50 and 60 and the indoor heat exchanger 200.

The air inlet 31, the filters 50 and 60, the indoor heat exchanger 200, and the air outlet 32 may be sequentially arranged based on a flow path of the air according to an operation of the fan 210. That is, the filters 50 and 60 may be arranged to adjoin the air inlet 31. In other words, the filters 50 and 60 may be arranged to be relatively closer to the air inlet 31 than the fan 210 and the indoor heat exchanger 200. Therefore, if the fan 210 is driven, the air of the air conditioning space may be heat-exchanged with the refrigerant in the indoor heat exchanger 200 after passing through the filters 50 and 60.

As the driving duration of the fan 210 continues, debris may be heaped up or collected in or on the filters 50 and 60. If the debris is heaped up in the filters 50 and 60, performance of the filters 50 and 60 may be deteriorated. Also, if the debris is heaped up in the filters 50 and 60, a wind speed according to driving of the fan 210 may be deteriorated relatively.

In this way, if a lifespan of the filters 50 and 60 ends, the filters 50 and 60 may be exchanged with new ones. However, a problem occurs in that a user cannot easily determine an exchanging timing of the filters 50 and 60. Therefore, an accumulated driving time of the filters 50 and 60 may be calculated to notify the user of the exchanging timing of the filters 50 and 60.

Also, the user may misunderstand deterioration of the wind speed of the air exhausted from the indoor unit I as a failure of the indoor unit I or a failure of the fan 210. Therefore, the user may be notified that the deterioration of the wind speed of the air is caused by the debris heaped up in the filters 50 and 60 before the user misunderstand the deterioration of the wind speed as described above.

A difference in lifespan of the filters 50 and 60 may occur depending on a condition of the air conditioning space in which the air conditioner is provided. For example, if the air conditioner is provided in a relatively dusty or smelly space, the lifespan of the filters 50 and 60 may be relatively short. On the contrary, if the air conditioner is provided in a relatively less-dusty or less-smelly space, the lifespan of the filters 50 and 60 may be relatively long.

Also, the filters 50 and 60 may include a dust filter 50 and a deodorizing filter 60. The dust filter 50 may be arranged to be closer to the air inlet 30 than the deodorizing filter 60. That is, the dust filter 50 and the deodorizing filter 60 may be arranged sequentially toward the fan 20 from the air inlet 31. Therefore, the air entering the air inlet 31 may sequentially pass through the dust filter 50 and the deodorizing filter 60.

Also, the lifespan of the dust filter 50 may be different from the lifespan of the deodorizing filter 60. Therefore, the exchanging timing of the dust filter 50 and the exchanging timing of the deodorizing filter 60 may be respectively determined and then notified or provided to the user.

Hereinafter, an embodiment, which may exactly determine exchanging timings of the filters 50 and 60 considering a condition of the air conditioning space and notify the user of the determined result, will be described.

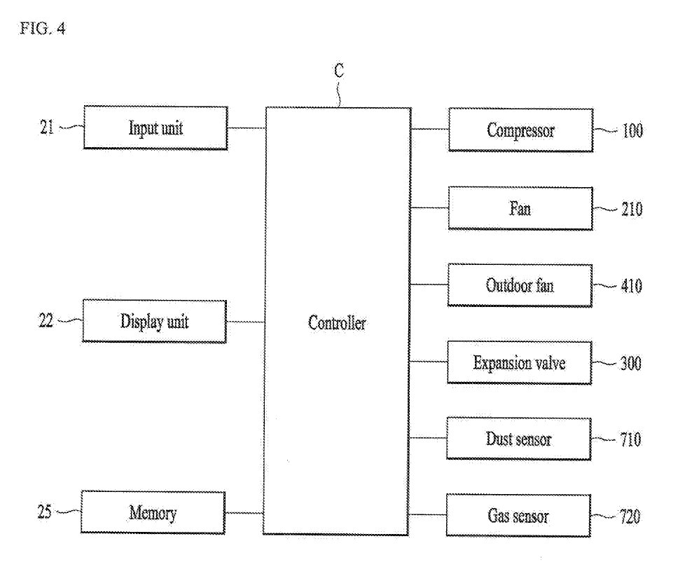

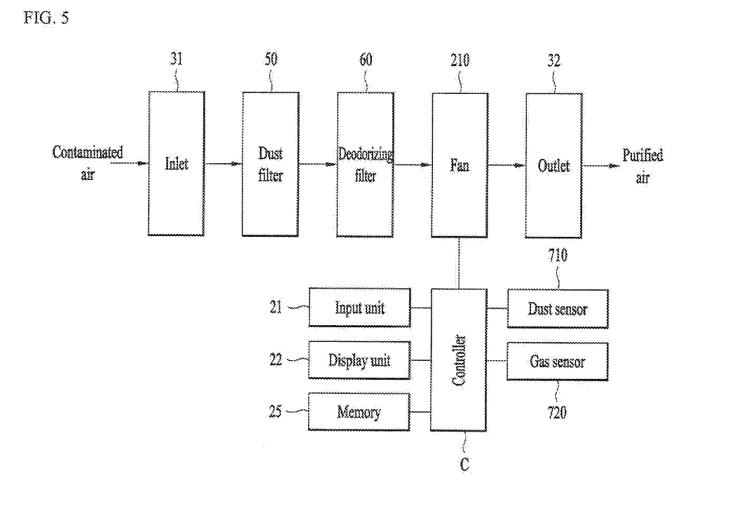

FIG. 4 is a block diagram illustrating a connection relationship of main components of the air conditioner shown in FIGS. 1 to 3. FIG. 5 is a block diagram illustrating a connection relation of main elements of an air cleaner as an embodiment of an air conditioner.

Referring to FIG. 4, the air conditioner may further include an input unit or input 21 that receives input of an operation mode by means of a user, a display unit or display 22 on which operation information of the air conditioner may be displayed, a memory 25 that stores information related to an accumulated driving time of the fan and a setup time for exchange of the filters 50 and 60, and a controller C that controls the input unit 21 and the display unit 22, electrically connected to the memory 25.

The input unit 21 and the display unit 22 may be formed in a single body, or may be formed separately from each other. Also, the input unit 21 and the display unit 22 may be in the form of a touch screen.

The controller C may also control the aforementioned compressor 100, fan 210, outdoor fan 410, and expansion valve 300. The controller C may be electrically connected to contamination sensors 710 and 720 provided in the air conditioning space. The contamination sensors 710 and 720 may be provided in the indoor unit I, or may be provided in a cable controller provided in the air conditioning space.

The contamination sensors 710 and 720 may include a dust sensor 710 and a gas sensor 720. The gas sensor 710 may mean a smell sensor that senses smell.

Also, referring to FIG. 5, as an embodiment of the air conditioner, the air cleaner may include an air inlet 31 into which contaminated air of the air conditioning space may flow, a dust filter 50, a deodorizing filter 60, a fan 210, and an outlet 32. The air entering the air cleaner through the inlet 31 by means of driving of the fan 210 may be exhausted to the outside of the air cleaner by sequentially passing through the dust filter 50, the deodorizing filter 60, the fan 210, and the outlet 32.

The fan 210 may be controlled by the controller C. The controller C may control the input unit 21, the display unit 22, and the memory 25. Also, the controller C may be electrically connected to the contamination sensors including the dust sensor 710 and the gas sensor 720.

As described above, the air conditioner according to FIGS. 1 to 3 is different from the air cleaner shown in FIG. 5 in that a compressor and a heat exchanger are provided for circulation of a refrigerant. That is, elements such as the compressor and the heat exchanger are not required for the air cleaner, especially an element such as the outdoor unit is not required for the air cleaner.

However, the embodiments of FIGS. 1 to 4 are similar to the embodiment of FIG. 5 in that the fan 210, the filters 50 and 60, and the contamination sensors 710 and 720 are provided and the filters 50 and 60 may be exchanged with new ones if their lifespan expires. Also, the filters 50 and 60 may be provided at a front end of the fan 210. That is, the filters 50 and 60 may be arranged above the fan 210 based on the flow path of the air moving by means of the fan 210. In other words, the filters 50 and 60 may be arranged between the fan 210 and the inlet 31. The dust filter 50 may be arranged to be closer to the inlet 31 than the deodorizing filter 60.

Referring to FIGS. 4 and 5, the fan 210 may suction the indoor air (that is, the air of the air conditioning space) and exhaust the suctioned air to the indoor space (that is, the air conditioning space). The fan 210 may be driven selectively at one of a plurality of wind speeds. For example, the wind speeds may include low speed, medium speed, and high speed.

The contamination sensors 710 and 720 may sense a contamination level of the indoor air. The dust sensor 710 may sense a level of dust included in the indoor air and sense a level of gas included in the indoor air. For example, the gas sensor 720 may be formed as a smell sensor that senses a level of smell included in the indoor air.

If the fan 210 is driven, the controller C may calculate an accumulated driving time of the fan 210. An amount of the air passing through the filters 50 and 60 for a unit time may be varied depending on the wind speed of the fan 210. Therefore, the controller C may calculate the accumulated driving time considering the wind speed of the fan 210.

That is, in the accumulated driving time of the fan 210, a weight value based on the wind speed may be applied to the time when the fan 210 is actually driven. That is, the controller C may apply the weight value based on the wind speed to the actual driving time of the fan 210 when calculating the accumulated driving time of the fan 210.

The controller C may apply the weight value to the actual driving time of the fan 210 as a gradually higher value in the order of low speed, medium speed, and high speed when calculating the accumulated driving time of the fan 210. Therefore, when the actual driving time of the fan 210 is equally maintained, the accumulated driving time may be the shortest in a case of the low speed and may be longest in a case of the high speed. In this respect, when the accumulated driving time is calculated by applying the weight value based on the wind speed to the actual driving time of the fan 210, the lifespan of the filters 50 and 60 may be determined more exactly than a case in which the lifespan of the fan 210 is determined by only the actual driving time of the fan 210.

The lifespan of the filters 50 and 60 may be changed depending on a contamination level of the indoor air. That is, if the contamination level of the indoor air is relatively high, the lifespan of the filters 50 and 60 may be relatively shorter. On the contrary, if the contamination level of the indoor air is relatively low, the lifespan of the filters 50 and 60 may be relatively longer.

Therefore, in order to more exactly determine an exchanging cycle of the filters 50 and 60, the accumulated driving time may be calculated by applying the weight value based on the contamination level of the indoor air to the actual driving time of the fan 210. That is, the controller C may apply a weight value based on values sensed by the contamination sensors 710 and 720 to the actual driving time of the fan 210 when calculating the accumulated driving time of the fan 210.

For example, the contamination sensors 710 and 720 may be formed to determine the contamination level of the indoor air as low, medium, or high. The weight value may be applied as a gradually higher value in the order of the contamination level of low, medium, and high. Therefore, when the actual driving time of the fan 210 is consistently maintained, the accumulated driving time may be shortest in a case of a low contamination level and may be longest in a case of a high contamination level. In this respect, when the accumulated driving time is calculated by applying the weight value based on the contamination level of the indoor air to the actual driving time of the fan 210, the lifespan of the filters 50 and 60 may be determined more exactly than in the case that the lifespan of the fan 210 is determined by only the actual driving time of the fan 210.

As described above, the controller C may calculate the accumulated driving time for exchanging the filters 50 and 60 by applying the weight value based on the wind speed of the fan 210 and the weight value based on the contamination level of the indoor air to the actual driving time of the fan 210. The controller C may determine that it is time to exchange the filters 50 and 60 when the accumulated driving time of the fan 210, which is calculated, reaches a predetermined time. That is, the controller C may determine that the lifespan of the filters 50 and 60 ends and exchange of the filters 50 and 60 is required when the calculated accumulated driving time of the fan 210 reaches the predetermined time or more.

The predetermined time may be stored in the memory 25, and the accumulated driving time of the fan 210, which is calculated by the controller C, may also be stored in the memory 25. The accumulated driving time stored in the memory 25 may be driven whenever the fan 210 is driven. Also, if the filters 50 and 60 are exchanged with other ones, the accumulated driving time stored in the memory 25 may be reset.

The filters 50 and 60 may include the dust filter 50 and the deodorizing filter 60. The contamination sensors 710 and 720 may include the dust sensor 710 and the gas sensor 720.

The lifespan of the dust filter 50 may be different from the lifespan of the deodorizing filter 60. That is, the exchanging cycle of the dust filter 50 may be different from the exchanging cycle of the deodorizing filter 60. Therefore, the accumulated driving time based on driving of the fan 210 may be categorized into the accumulated driving time for the dust filter 50 and the accumulated driving time for the deodorizing filter 60.

That is, the accumulated driving time of the fan 210, which is calculated by the controller C, may be stored in the memory 25, and the accumulated driving time of the fan 210 may be stored in the memory 25 by being identified for each of the dust filter 50 and the deodorizing filter 60. The accumulated driving time of the fan 210 for determining the exchanging cycle of the dust filter 50 may be stored in the memory 25 as a first accumulated driving time. The first accumulated driving time may be calculated as the weight value based on the wind speed and the weight value based on the contamination level sensed by the dust sensor 710 to the actual driving time of the fan 210.

Also, the accumulated driving time of the fan 210, which is intended to determine the exchanging cycle of the deodorizing filter 60, may be stored in the memory 25 as a second accumulated driving time. The second accumulated driving time may be calculated as the weight value based on the wind speed and the weight value based on the contamination level sensed by the gas sensor 720 to the actual driving time of the fan 210.

The first accumulated driving time and the second accumulated driving time may be different from each other due to the above calculation. The predetermined time may include a first time previously set to determine the exchanging cycle of the dust filter 50 and a second time previously set to determine the exchanging cycle of the deodorizing filter 60. The first time and the second time may be different from each other and may be stored in the memory 25.

If it is time to exchange the filters 50 and 60, information on the exchange of the filters 50 and 60 may be provided to the user through the display unit 22. The controller C may control the display unit 22 to display the information on the exchange of the dust filter 50 on the display unit 22 when the accumulated driving time of the fan 210, which is calculated, reaches the first time. That is, when the first accumulated driving time of the fan 210 reaches the first time or more, the controller C may notify the user of the information on the exchange of the dust filter 50 through the display unit 22.

Also, the controller C may control the display unit 22 to display the information on the exchange of the deodorizing filter 60 on the display unit 22 when the accumulated driving time of the fan 210, which is calculated, reaches the second time. That is, when the second accumulated driving time of the fan 210 reaches the second time or more, the controller C may notify the user of the information on the exchange of the deodorizing filter 60 through the display unit 22.

As described above, according to embodiments, the weight value may be applied to the actual driving time of the fan depending on the state of the air of the indoor space (or the air conditioning space), whereby the exchanging timing of each of the filters may be determined more exactly.

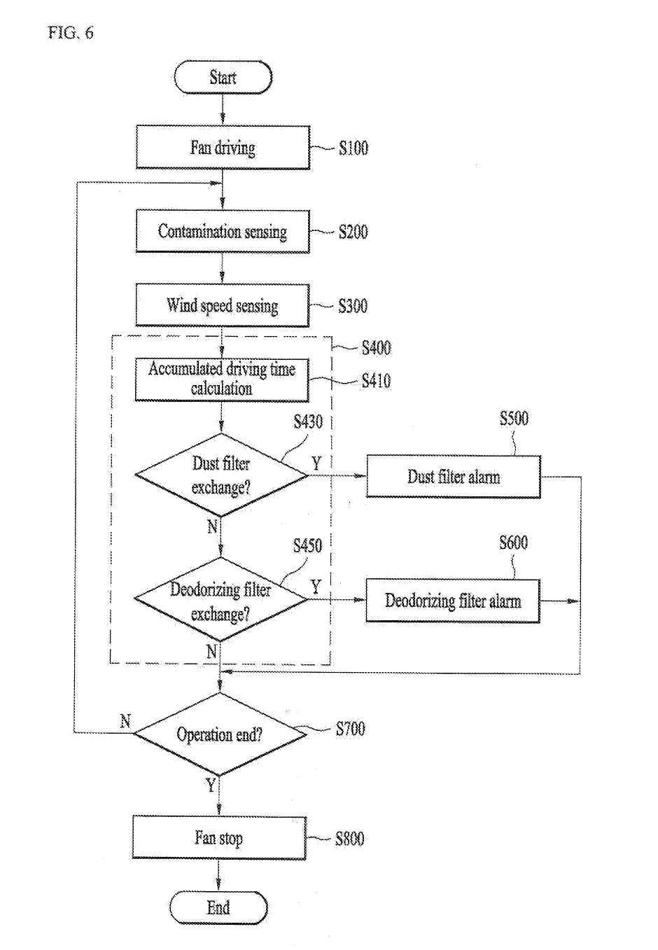

FIG. 6 is a flow chart of a method for controlling an air conditioner according to an embodiment. In the description of a method for controlling the air conditioner with reference to FIG. 6, it will be apparent that the aforementioned configuration of the air conditioner may be applied to the method for controlling the air conditioner.

Referring to FIG. 6, the method for controlling the air conditioner according to an embodiment may include a fan driving step or operation S100 of initiating driving of a fan, such as fan 210, a wind speed sensing step or operation S300 of sensing a wind speed of the fan 210, and a filter exchange determining step or operation S400 of determining an exchanging timing of filters, such as filters 50 and 60. In the fan driving step S100, driving of the fan 210 may be initiated by an input of a control command from a user.

In the wind speed sensing step S300, the wind speed of the fan 210 may be sensed or detected by a controller, such as controller C. The wind speed of the fan 210 may include low speed, medium speed, and high speed, which may be determined based on RPM of the fan 210.

In the filter exchange determining step S400, the exchanging timing of the filters 50 and 60 may be determined based on the accumulated driving time of the fan 210. The accumulated driving time of the fan may be calculated by the controller C considering the wind speed of the fan 210, and the exchanging timing of the filters 50 and 60 may be determined by the controller C on the basis of the accumulated driving time.

The filter exchange determining step S400 may include an accumulated driving time calculating step or operation S410. In the accumulated driving time calculating step S410, the accumulated driving time may be calculated in such a manner that a weight value based on the wind speed is applied to the actual driving time of the fan 210.

That is, when the accumulated driving time is calculated in the accumulated driving time calculating step S410, the weight value based on the wind speed of the fan 210 may be applied to the actual driving time of the fan 210. If the wind speed is changed while the fan 210 is being driven, the weight value based on the wind speed may also be changed. If the wind speed is high, a high weight value may be applied to the actual driving time of the fan 210. That is, when the accumulated driving time is calculated based on the actual driving time, the weight value may be applied as a gradually higher value in the order of the wind speed of low, medium, and high.

For example, the low wind speed may have a weight value of 1, the medium wind speed may have a weight*value of 2, and the high wind high may have a weight value of 3. That is, when the actual driving time of the fan 210 is one hour and the wind speed is high, the accumulated driving time may be three hours (=1*3). In contrast, when the actual driving time of the fan 210 is one hour and the wind speed is low, the accumulated driving time may be one hour (=1*1).

The exchanging cycle of the filters 50 and 60 may be changed depending on the contamination level of the indoor air. Therefore, the method for controlling the air conditioner according to embodiments may further include a contamination level sensing step or operation S200 for sensing a contamination level of an air conditioning space. The contamination level sensing step S200 may be performed prior to the fitter exchange determining step S400. In the contamination level sensing step S200, the contamination level of the indoor air may be sensed through contamination sensors, such as contamination sensors 710 and 720, and the contamination level of the indoor air may be determined as high, medium, or low.

When the accumulated driving time is calculated in the accumulated driving time calculating step S410, the weight value may be applied to the actual driving time of the fan 210 in accordance with the contamination level. For example, the weight value of 3 may be applied to the contamination level of high, the weight value of 2 may be applied to the contamination level of medium, and the weight value of 1 may be applied to the contamination level of low. That is, when the actual driving time of the fan 210 is one hour and the contamination level of the indoor air is medium, the accumulated driving time may be two hours (=1*2). In contrast, when the actual driving time of the fan 210 is one hour and the contamination level of the indoor air is high, the accumulated driving time may be three hours (=1*3).

As described above, as the accumulated driving time for determining the exchanging timing of the filters 50 and 60 may be calculated by applying the weight value based on the contamination level of the indoor air to the actual driving time of the fan, the exchanging timing of the filters 50 and 60 may be determined more exactly. More particularly, both the weight value based on the wind speed and the weight value based on the contamination level may be applied to the actual driving time of the fan 210. For example, when the actual driving time of the fan 210 is one hour, the wind speed is high, and the contamination level is high, the accumulated driving time may be nine hours (=1*3*3).

The filters 50 and 60 may include the dust filter 50. The contamination sensors 710 and 720 may include the dust sensor 710 and the gas sensor 720. In the accumulated driving time calculating step S410, the weight value based on the contamination level sensed by the dust sensor 710 and the weight value based on the contamination level sensed by the gas sensor 720 may be identified from each other and then applied to the actual driving time of the fan 210.

That is, the contamination level sensed by the dust sensor 710 may be used to calculate the accumulated driving time for determining the exchanging timing of the dust filter 50. In contrast, contamination level sensed by the gas sensor 720 may be used to calculate the accumulated driving time for determining the exchanging timing of the deodorizing filter 60.

For example, the accumulated driving time for determining the exchanging timing of the dust filter 50 and the accumulated driving time for determining the exchanging timing of the deodorizing filter 60 may be calculated respectively as listed in Table 1 below. The contamination level in the calculation of the accumulated driving time for the dust filter 50 may be detected by the dust sensor 710, and the contamination level in the calculation of the accumulated driving time for the deodorizing filter 60 may be detected by the gas sensor 720.

TABLE 1

| | Actual | | Contam- | Calculated |
|---|---|---|---|---|
| | driving | Wind | ination | accumulated |
| | time of fan | speed | level | driving time |
| Dust filter | 1 hour | High (3) | High (3) | 1*3*3 = 9 hours |
| Deodorizing | 1 hour | Medium (2) | Low (1) | 1*2*1 = 4 hours |
| filter | | | | |

The filter exchange determining step 400 may further include a first determining step or operation S430 for determining whether to exchange the dust filter 50, and a second determining step or operation S450 for determining whether to exchange the deodorizing filter 60. In the first determining step S430, whether to exchange the dust filter 50 may be determined by the controller C through comparison between the accumulated driving time calculated in the accumulated driving time calculating step 410 and the first time previously set to exchange the dust filter 50. In the second determining step S450, whether to exchange the deodorizing filter 60 may be determined by the controller C through comparison between the accumulated driving time calculated in the accumulated driving time calculating step S410 and the second time previously set to exchange the deodorizing filter 60.

The accumulated driving time calculated in the accumulated driving time calculating step S410 may include a first accumulated driving time for exchanging the dust filter 50 and a second accumulated driving time for exchanging the deodorizing filter 60. The first accumulated driving time and the second accumulated driving time may be calculated respectively and then stored in the memory 25.

The first accumulated driving time may be calculated as the weight value based on the wind speed and the weight value based on the contamination level sensed by the dust sensor 710 to the actual driving time of the fan 210. In contrast to the first accumulated driving time, the second accumulated driving time may be calculated as the weight value based on the wind speed and the weight value based on the contamination level sensed by the gas sensor 720 to the actual driving time of the fan 210.

As described above, the exchanging cycle or the exchanging timing of each of the dust filter 50 and the deodorizing filter 60 may be determined separately through the filter exchange determining step 400.

The method for controlling an air conditioner according to embodiments invention may further include a first alarm step or operation of providing an alarm for the exchanging timing of the dust filter 50 and a second alarm step or operation of providing an alarm for the exchanging timing of the deodorizing filter 60. In the first determining step S430, if it is determined that the accumulated driving time (that is, the first accumulated driving time) reaches the first time, an alarm for the exchange of the dust filter 50 may be provided to the user through the display unit 22 in the first alarm step S00. In the second determining step S450, if it is determined that the accumulated driving time (that is, the second accumulated driving time) reaches the second time, an alarm for the exchange of the deodorizing filter 60 may be provided to the user through the display unit 22 in the second alarm step S600.

After the filter exchange determining step S400, whether the operation of the air conditioner has been ended (that is, whether driving of the fan has been ended) may be determined by the controller C (S700). If the fan 210 is driven continuously without being ended, the steps of calculating the aforementioned accumulated driving time and determining the exchanging timing of the filter may be repeated.

Accordingly, embodiments disclosed herein are directed to an air conditioner and a method for controlling an air conditioner, which substantially obviate one or more problems due to limitations and disadvantages of the related art. Embodiments disclosed herein provide an air conditioner and a method for controlling an air conditioner, in which an exchanging timing of a filter may be determined more exactly based on an arrangement condition of an indoor unit. Embodiments disclosed herein further provide an air conditioner and a method for controlling an air conditioner, which may prevent a user from misunderstanding deterioration of a wind speed of the air exhausted from an indoor unit as a failure of a fan or the indoor unit.

Additional advantages, objects, and features will be set forth in part in the description and in part will become apparent to those having ordinary skill in the art upon examination of this disclosure or may be learned from practice. The objectives and other advantages may be realized and attained by the structure particularly pointed out in the written description and claims hereof as well as the appended drawings.

Embodiments disclosed herein provide an air conditioner that may include a fan formed to suction indoor air and exhaust the suctioned air to an indoor space and driven selectively at one of a plurality of wind speeds; a filter provided at a front end of the fan; a contamination sensor that senses a contamination level of the indoor air; and a controller electrically connected to the fan and the contamination sensor. An accumulated driving time of the fan may be calculated by the controller considering the wind speeds, and an exchanging timing of the filter may be determined by the controller on the basis of the accumulated driving time of the fan. The wind speeds may include low speed, medium speed, and high speed.

The controller may apply a weight value based on the wind speed to an actual driving time of the fan when calculating the accumulated driving time of the fan. The controller may apply the weight value as a gradually higher value in the order of the wind speed of low, medium, and high when calculating the accumulated driving time of the fan.

The controller may apply a weight value based on a value sensed by the contamination sensor to the actual driving time of the fan when calculating the accumulated driving time of the fan. A greater weight value may be applied with respect to a greater value sensed by the contamination sensor. The controller may determine an exchanging timing of the filter if the accumulated driving time of the fan, which is calculated, reaches a predetermined time.

The filter may include a dust filter and a deodorizing filter. The contamination sensor may include a dust sensor and a gas sensor.

The predetermined time may include a first time previously set to determine an exchanging timing of the dust filter and a second time previously set to determine an exchanging timing of the deodorizing filter. The first time and the second time may be different from each other.

The air conditioner may further include a display unit or display formed to display its operation information. The controller may control the display unit to display information on exchange of the dust filter on the display unit if the accumulated driving time of the fan, which is calculated, reaches the first time. The controller may control the display unit to display information on exchange of the deodorizing filter on the display unit if the accumulated driving time of the fan, which is calculated, reaches the second time.

The air conditioner may further include a memory that stores the accumulated driving time of the fan, the first time and the second time, and the accumulated driving time of the fan may be stored in the memory to be identified for each of the dust filter and the deodorizing filter.

Embodiments disclosed herein provide a method for controlling an air conditioner, which may include a fan, filter, and a contamination sensor, may include a fan driving step or operation of initiating driving of the fan; a wind speed sensing step or operation of sensing a wind speed of the fan; and a filter exchange determining step or operation of determining an exchanging timing of the filter on the basis of an accumulated driving time of the fan. The accumulated driving time of the fan may be calculated in the filter exchange determining step considering the wind speed, and the exchanging timing of the filter may be determined on the basis of the accumulated driving time.

The filter exchange determining step may include an accumulated driving time calculating step or operation, and the wind speed of the fan may include low speed, medium speed, and high speed. A weight value based on the wind speed may be applied when the accumulated driving time is calculated. The weight value may be applied as a gradually higher value in the order of the wind speed of low, medium, and high when the accumulated driving time is calculated.

The method may further include a contamination sensing step or operation of sensing a contamination level of an air conditioning space, which may be sensed by a contamination sensor, prior to the filter exchange determining step. The weight value may be applied in accordance with the contamination level sensed in the contamination sensing step. A greater weight value may be applied for calculation of the accumulated driving time with respect to a greater contamination level sensed in the contamination sensing step.

The filter may include a dust filter, and the filter exchange determining step may further include a first determining step or operation of determining whether to exchange the dust filter through comparison between the accumulated driving time which is calculated and a first time previously set to determine an exchanging timing of the dust filter.

The filter may further include a deodorizing filter arranged at one side of the dust filter, and the filter exchange determining step may further include a second determining step or operation of determining whether to exchange the deodorizing filter through comparison between the accumulated driving time which is calculated and a second time previously set to determine an exchanging timing of the deodorizing filter.

The method may further include a first alarm step or operation of providing an alarm for exchange of the dust filter through the display unit if the accumulated driving time reaches the first time in the first determining step, and a second alarm step or operation of providing an alarm for exchange of the deodorizing filter through the display unit if the accumulated driving time reaches the second time in the second determining step.

According to embodiments disclosed herein, the exchanging timing of the filter may be determined more exactly based on an arrangement condition of the indoor unit. Also, according to embodiments disclose herein, the exchanging timing of each of different filters may be determined and then its alarm may be provided to a user. Also, according to embodiments disclose herein, deterioration of the wind speed of the air exhausted from the indoor unit may be prevented from being misunderstood by a user as a failure of a fan or the indoor unit.

It will be apparent to those skilled in the art that embodiments can be embodied in other specific forms without departing from the spirit and essential characteristics. Thus, the embodiments are to be considered in all respects as illustrative and not restrictive. The scope should be determined by reasonable interpretation of the appended claims and all change which comes within the equivalent scope are included in the scope.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioner, comprising:
a fan that suctions in indoor air from an indoor space and exhausts the suctioned air to the indoor space, wherein the fan is selectively driven at one of a plurality of wind speeds;
at least one filter provided adjacent to the fan;
at least one contamination sensor that senses a contamination level of the indoor air; and
a controller electrically connected to the fan and the at least one contamination sensor, wherein an accumulated driving time of the fan is calculated by the controller considering the wind speed, and an exchanging timing of the at least one filter is determined by the controller on the basis of the accumulated driving time of the fan.

2. The air conditioner according to claim 1, wherein the plurality of wind speeds includes low speed, medium speed, and high speed, and the controller applies a weight value based on the wind speed to an actual driving time of the fan when calculating the accumulated driving time of the fan.

3. The air conditioner according to claim 2, wherein the controller applies the weight value as a gradually higher value in the order of the wind speed of low, medium, and high when calculating the accumulated driving time of the fan.

4. The air conditioner according to claim 2, wherein the controller applies a weight value based on a value sensed by the at least one contamination sensor to the actual driving time of the fan when calculating the accumulated driving time of the fan.

5. The air conditioner according to claim 4, wherein a greater weight value is applied with respect to a greater value sensed by the at least one contamination sensor.

6. The air conditioner according to claim 4, wherein the controller determines the exchanging timing of the filter if the accumulated driving time of the fan, which is calculated, reaches a predetermined time.

7. The air conditioner according to claim 6, wherein the at least one filter includes a dust filter and a deodorizing filter, and the at least one contamination sensor includes a dust sensor and a gas sensor.

8. The air conditioner according to claim 7, wherein the predetermined time includes a first time previously set to determine an exchanging timing of the dust filter and a second time previously set to determine an exchanging timing of the deodorizing filter, and the first time and the second time are different from each other.

9. The air conditioner according to claim 8, further including a display that displays operation information of the air conditioner, wherein the controller controls the display to display information on exchange of the dust filter on the display if the accumulated driving time of the fan, which is calculated, reaches the first time.

10. The air conditioner according to claim 9, wherein the controller controls the display to display information on exchange of the deodorizing filter on the display if the accumulated driving time of the fan, which is calculated, reaches the second time.

11. The air conditioner according to claim 9, further including a memory that stores the accumulated driving time, of the fan, the first time and the second time, wherein the accumulated driving time of the fan is stored in the memory for each of the dust filter and the deodorizing filter.

12. A method for controlling an air conditioner, the air conditioner including a fan, at least one filter, and at least one contamination sensor, the method comprising:
initiating driving of the fan;
sensing a wind speed of the fan; and
determining an exchanging timing of the at least one filter on the basis of an accumulated driving time of the fan, wherein the accumulated driving time of the fan is calculated considering the wind speed, and the exchanging timing of the at least one filter is determined on the basis of the accumulated driving time.

13. The method according to claim 12, wherein the determining of the exchanging time of the at least one filter includes calculating the accumulated driving time of the fan, wherein the wind speed of the fan includes low speed, medium speed, and high speed, and wherein a weight value based on the wind speed is applied when the accumulated driving time is calculated.

14. The method according to claim 13, wherein the weight value is applied as a gradually higher value in the order of the wind speed of low, medium, and high when the accumulated driving time is calculated.

15. The method according to claim 13, further sensing a contamination level of an air conditioning space by the at least one contamination sensor, prior to the determining of the exchanging time of the at least one filter, wherein the weight value is applied in accordance with the contamination level sensed by the at least one contamination sensor.

16. The method according to claim 15, wherein a greater weight value is applied for calculation of the accumulated driving time with respect to a greater contamination value sensed by the at least one contamination level sensor.

17. The method according to claim 15, wherein the at least one filter includes a dust filter, and the determining of the exchanging time of the at least one filter further includes determining whether to exchange the dust filter through comparison between the accumulated driving time which is calculated and a first time previously set to determine an exchanging timing of the dust filter.

18. The method according to claim 17, further including providing an alarm for exchange of the dust filter through a display if the accumulated driving time reaches the first time.

19. The method according to claim 17, wherein the at least one filter further includes a deodorizing filter, and the determining of the exchanging time of the at least one filter further includes determining whether to exchange the deodorizing filter through comparison between the accumulated driving time which is calculated and a second time previously set to determine an exchanging timing of the deodorizing filter.

20. The method according to claim 19, further including providing an alarm for exchange of the deodorizing filter through a display if the accumulated driving time reaches the second time.

21. Apparatus for controlling an air conditioner, the air conditioner including a fan, at least one filter, and at least one contamination sensor, the apparatus comprising:
means for initiating driving of the fan;
means for sensing a wind speed of the fan; and
means for determining an exchanging timing of the at least one filter on the basis of an accumulated driving time of the fan, wherein the accumulated driving time of the fan is calculated considering the wind speed, and the exchanging timing of the at least one filter is determined on the basis of the accumulated driving time.
